(19) United States
(12) Patent Application Publication
(10) Pub. No.: US 2014/0317536 A1
(43) Pub. Date: Oct. 23, 2014

(54) Browser Dialogue Box Wrapper

(71) Applicants: Hanyang Liu, San Francisco, CA (US); John Denis Woods, San Francicso, CA (US); Sebastian Tonkin, San Francisco, CA (US)

(72) Inventors: Hanyang Liu, San Francisco, CA (US); John Denis Woods, San Francicso, CA (US); Sebastian Tonkin, San Francisco, CA (US)

(73) Assignee: Google Inc., Mountain View, CA (US)

(21) Appl. No.: 13/440,920

(22) Filed: Apr. 5, 2012

(51) Int. Cl. G06F 3/048

(52) U.S. Cl. 715/760; 715/788

(57) ABSTRACT

The subject technology provides an overlay for providing contextual information (e.g., instructions) to assist a user in interacting with a dialog box. The subject technology initially detects a click event (e.g., mouse click, touch input, voice input, etc.) that activates the aforementioned dialog box, and then renders an overlay providing contextual information for responding to the dialog box. The overlay serves as a “wrapper” that provides visual cues and/or contextual information (e.g., text or instructions) to facilitate or influence the user to make a choice that is desirable to a sponsor of the offer page (e.g., setting the default home page to the sponsor's web site). Based on the information provided by the overlay, the user performs a one or more actions to interact with the dialog box (which then loads an ensuing web page once the dialog box is closed).

### BACKGROUND

A dialog box provided by an application can include different options and provide graphical elements for selecting the one or more options. Depending on the options, a user can be confused by too many options that are presented in the dialog box.

### SUMMARY

The subject technology provides a custom overlay for a dialog box in an application. A click event is detected in content displayed in the application for activating a dialog box in which the content is provided by a different source than the application. The subject technology provides, in response to the detected click event, an overlay in the application, the overlay including contextual information for instructing a user to interact with the dialog box before the dialog box is rendered by the application. The overlay and the dialog box rendered by the application are then provided for display.

Yet another aspect of the subject technology provides a system for providing a custom overlay for a dialog box in an application. The system includes memory, one or more processors and one or more modules stored in memory and configured for execution by the one or more processors. The system includes an event detection module configured to detect a click event in content displayed in the application for activating a dialog box in which the content is provided by a different source than the application and the different source comprises a web site located over a network. The system also includes an overlay module configured to provide, in response to the detected click event, an overlay in the application, the overlay including contextual information for instructing a user to interact with the dialog box before the dialog box is rendered by the application. Additionally, the system includes a graphical user interface (GUI) module configured to provide for display the overlay and the dialog box rendered by the application.

The subject technology further provides for detecting a click event in content displayed in an application for activating a dialog box in which the content is provided by a different source than the application, and the application is a web browser. The subject technology provides, in response to the detected click event, an overlay in the application, the overlay including contextual information for instructing a user to interact with the dialog box before the dialog box is rendered by the application. In some configurations, the overlay includes one or more HTML elements that are pre-cached. Further, the subject technology provides for display the overlay and the dialog box rendered by the application. In one example, the overlay is displayed before the dialog box is rendered by the application.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The novel features of the subject technology are set forth in the appended claims. However, for purpose of explanation, several configurations of the subject technology are set forth in the following figures.

FIG. 1 conceptually illustrates an example process for providing a custom overlay for a dialog box in an application.

FIG. 2 conceptually illustrates a graphical user interface (GUI) in different stages in which some configurations of the subject technology can be implemented.

FIG. 3 conceptually illustrates an example computing environment.

FIG. 4 conceptually illustrates an example application programming interface (API) architecture.

FIG. 5 is an example of a mobile device architecture.

FIG. 6 conceptually illustrates a system with which some implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

In a given web site, a user navigates and interacts with the web site while utilizing a web client, such as a web browser. The web site can include one or more web pages that form a sequence or flow (e.g., web page A -->web page B -->web page C, etc.) that define the user experience (e.g., a navigational path) for the web site. In one example, in response to a user interaction with an element (e.g., a button) on a particular web page, the web browser can activate a dialog box for display. A dialog box can include different options and provide graphical elements for selecting one or more options. Further, the dialog box can either be modal (requiring a user response to revert control back to the web browser) or modeless (allowing the user to continue using the web browser without responding to the dialog box). One example of a modal dialog box is one that sets a default home page for the web browser. When a user sets a default home page on a given web browser, a modal dialog box including a “Yes/No” and/or other options can be rendered and displayed to the user.

Depending on the context in which the dialog box is presented, the user may find interacting with the dialog box to be confusing or jarring to the overall user experience. For instance, a Wi-Fi vendor may present a splash page (e.g., a web page that acts as an initial page prior to displaying a subsequent page) to the user for accepting terms of use before loading a following web page with an offer (e.g., an offer page) to set a certain web site as the user's home page. The web page can include an element (e.g., a button) for accepting the offer (e.g., set the user's home page to the desired web site). Alternatively, the splash page and the offer page can be included on the same page for presenting to the user. In response to user input for accepting the offer (e.g., by selecting a graphical element), a modal dialog box is rendered for display including one or more options (e.g., “Yes,” “No,” “Cancel,” etc.) provided by different graphical elements (button, radio button, checkbox, etc.).

For improving the user experience, the subject technology detects a click event (e.g., mouse click, touch input, voice input, etc.) that activates the aforementioned dialog box, and then renders an overlay providing contextual information for responding to the dialog box. The overlay serves as a “wrapper” that provides visual cues and/or contextual information (e.g., text or instructions) to facilitate or influence the user to make a choice that is desirable to a sponsor of the offer page (e.g., setting the default home page to the sponsor's web site). Based on the information provided by the overlay, the user performs a one or more actions to interact with the dialog box (which then loads an ensuing web page once the dialog box is closed).

In order to provide a more seamless user experience, the subject technology can render the overlay in a sufficiently short period of time to enable the overlay to be rendered substantially the same time as the dialog box by the web browser. Given this time constraint, the subject technology can optimize certain aspects of the presentation of the overlay, including, but not limited to, pre-caching one or more images (or other graphical elements) and/or HTML elements utilized by the overlay. Other types of optimizations can be provided as well. In another example, the subject technology can provide different ways for presenting the overlay. For instance, the overlay is rendered according to an opacity setting to provide a transparency effect over the web page.

Although the above example relates to the modal dialog box, an overlay(s) can be provided for other types of dialog boxes and still be within the scope of the subject technology. Additionally, the above example describes a web browser as an example. However, the subject technology enables an overlay to be displayed with any type of dialog box for any type of application. In this fashion, the subject technology provides an overlay for any sort of dialog box provided by any type of application.

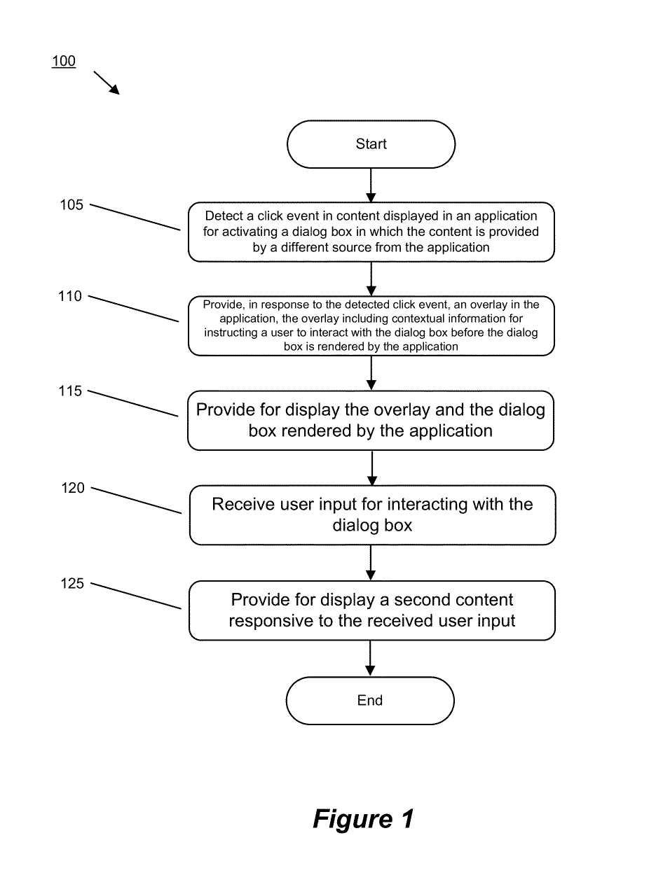

FIG. 1 conceptually illustrates an example process 100 for providing a custom overlay for a dialog box in an application. The application is a web browser in one example. In some configurations, the process 100 can be implemented by one or more computing devices or systems.

The process 100 begins at 105 by detecting a click event in content displayed in the application for activating a dialog box in which the content is provided by a different source than the application. The click event occurs in a web page displayed by the web browser in one example (e.g., upon selection of a graphical element to activate a dialog box). More specifically, the click event corresponds with a button selection in the content in some configurations. The web page is provided by a web site (the contents of which are outside of the control of the web browser or application).

The process 100 at 110 provides, in response to the detected click event, an overlay in the application, the overlay including contextual information for instructing a user to interact with the dialog box before the dialog box is rendered by the application. The overlay includes one or more different HTML elements that wrap around the dialog box in one example. To optimize performance, at least one of the different HTML elements is pre-cached by the web browser in one example. Further, the overlay can be dynamically generated.

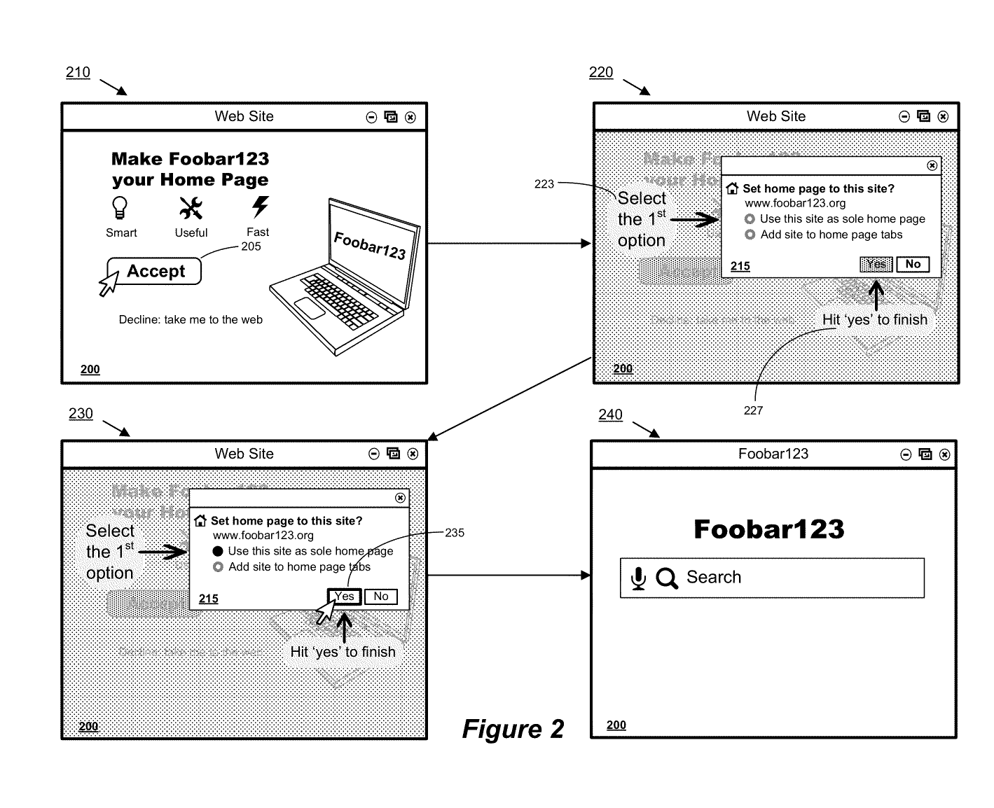

The process 100 at 115 provides for display the overlay and the dialog box rendered by the application. In this regard, the process 100 displays the overlay before or substantially around the time that the dialog box is rendered by the application. The overlay is provided for display in the web page in one example. In some configurations, the dialog box is a modal dialog box in which interaction with other portions of the application is blocked until a user responds to the dialog box. An example depiction of the overlay is described in further detail in FIG. 2 below. In one example, the overlay is rendered according to an opacity setting to provide a transparency effect over the content in order to improve the readability of any contextual information (e.g., text, images, etc.) provided by the overlay.

The process 100 at 120 receives user input for interacting with the dialog box. The received user input includes one or more types of input. For instance, the one or more types of input include mouse input, keyboard input, touch input, and/or voice input. Other types of input can be received and still be within the scope of the subject technology. The process 100 at 125 provides for display a second content responsive to the received user input. In one example, the second content is a second web page. Other types of content can be provided and still be within the scope of the subject technology. The process 100 then ends.

FIG. 2 conceptually illustrates a graphical user interface (GUI) in different stages in which some configurations of the subject technology can be implemented. More specifically, FIG. 2 illustrates a graphical user interface 200 in different operational stages 210, 220, 230 and 240 for providing an overlay for a dialog box that is activated in an application (e.g., a web browser, etc.). The GUI 200 can include different sets of graphical elements. A graphical element can include, but is not limited to, a button, check box, radio button, slider, list box, drop-down list, menu, combo box, icon, text box, scroll bar, etc.

In the first stage 210, the graphical user interface (GUI) 200 displays a web page including a button 205 for activating a dialog box in an application. In the example GUI 200, a user can accept an offer on the web page (e.g., to set a particular web site or web page as their home page) by selecting the button 205, which upon selection activates the dialog box for completing the offer. Content included in the web page shown in the first stage 210 is provided by a web site that is outside of the control of the application and its GUI. For instance, the content can include a splash page for a vendor (e.g., Wi-Fi vendor). Other types of content can be provided and still be within the scope of the subject technology.

In the second stage 220, after the dialog box is activated, an overlay including contextual information for instructing a user to interact with a dialog box 215 is displayed in the GUI 200. In the example GUI 200, the dialog box 215 is shown with two different options as respective radio buttons and two buttons corresponding to “Yes” and “No” responses. As further illustrated in the second stage 220, contextual information 223 and 227 are provided in order to guide the user with interacting with the dialog box 215.

As shown in the third stage 230, the GUI 200 includes the dialog box 215 after the user has selected the radio button corresponding to the first option (e.g., shown as “Use this site as sole home page”). The user can then select the button 235 corresponding to a “Yes” response in order to complete the action for setting the home page to the web site (e.g., “www.foobar123.org”) shown in the dialog box 215.

In the example of FIG. 2, the fourth stage 240 shows that a second content is provided for display in the GUI 200 after the user has provided input for selecting the button 235 from the third stage 230. As shown in the example GUI 200, the second content is a corresponding web site that the user has set their home page based on the interaction with the dialog box previously shown in the third stage 230.

Although the above description of FIG. 2 includes different example graphical elements in the GUI 200, some implementations can include other graphical elements in the GUI 200 and still be within the scope of the subject technology. Further, the GUI 200 is not required to include all of the aforementioned graphical elements.

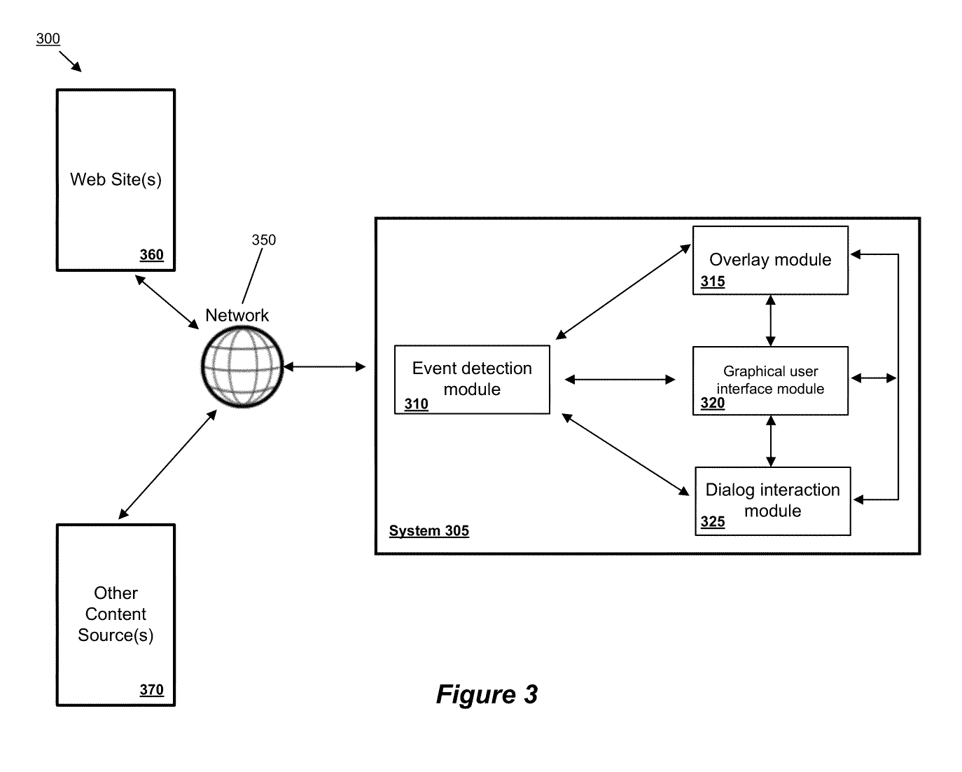

FIG. 3 conceptually illustrates an example computing environment 300 including a system. In particular, FIG. 3 shows a system 305 for implementing the above described process in FIG. 1 the example GUI in FIG. 2. In some configurations, the system 305 is part of an implementation running a particular machine (e.g., a computing device, mobile device, etc.).

The system 305 can include memory, one or more processors, and one or more modules stored in memory and configured for execution by the one or more processors. As shown in FIG. 3, the system 305 includes several modules for providing different functionality. More specifically, the system 305 includes an event detection module 310, an overlay module 315, a graphical user interface (GUI) module 320 and a dialog interaction module 325. The event detection module 310 is configured to detect a click event in content displayed in the application for activating a dialog box in which the content is provided by a different source than the application. In some configurations, the different source is a web site located over a network. The dialog box is a modal dialog box in some instances. The click event corresponds with a button selection in the content in one example. The overlay module 315 is configured to provide, in response to the detected click event, an overlay in the application, the overlay including contextual information for instructing a user to interact with the dialog box before the dialog box is rendered by the application. For instance, the overlay includes one or more different HTML elements that wrap around the dialog box and the overlay is dynamically generated. At least one of the different HTML elements is pre-cached by the web browser or application in some configurations. The GUI module 320 is configured to provide for display the overlay and the dialog box rendered by the application. The overlay is rendered according to an opacity setting to provide a transparency effect over the content in one example. The dialog interaction module 325 is configured to receive user input for interacting with the dialog box. In some configurations, the GUI module 320 is further configured to provide for display a second content (e.g., a second web page, other content, etc.) responsive to the received user input.

As further shown in FIG. 3, each of the aforementioned modules can be configured to communicate between each other. For instance, different data, messages, API calls and returns can be passed between the different modules in the system 305.

The system 305 can communicate over a network 350 with a web site(s) 360. The web site 360 can each be configured to communicate with the aforementioned modules of the system 305. For instance, the system 305 can transmit a request for content over the network 350 to the web site 360 and the web site 360 can respond to the request by transmitting the requested content over the network 350 to the system 305. As further shown in FIG. 3, the system 305 can communicate over the network 350 with other content source(s) 370 (e.g., additional web sites, data sources, etc.) in a similar manner.

Many of the above-described features and applications are implemented as software processes that are specified as a set of instructions recorded on a machine readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of machine readable media include, but are not limited to, CD-ROMs, flash drives, RAM chips, hard drives, EPROMs, etc. The machine readable media does not include carrier waves and electronic signals passing wirelessly or over wired connections.

In this specification, the term “software” is meant to include firmware residing in read-only memory and/or applications stored in magnetic storage, which can be read into memory for processing by a processor. Also, in some implementations, multiple software components can be implemented as sub-parts of a larger program while remaining distinct software components. In some implementations, multiple software subject components can also be implemented as separate programs. Finally, any combination of separate programs that together implement a software component(s) described here is within the scope of the subject technology. In some implementations, the software programs, when installed to operate on one or more systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some configurations are implemented as software processes that include one or more application programming interfaces (APIs) in an environment with calling program code interacting with other program code being called through the one or more interfaces. Various function calls, messages or other types of invocations, which can include various kinds of parameters, can be transferred via the APIs between the calling program and the code being called. In addition, an API can provide the calling program code the ability to use data types or classes defined in the API and implemented in the called program code.

One or more APIs may be used in some configurations. An API is an interface implemented by a program code component or hardware component (“API implementing component”) that allows a different program code component or hardware component (“API calling component”) to access and use one or more functions, methods, procedures, data structures, classes, and/or other services provided by the API implementing component. An API can define one or more parameters that are passed between the API calling component and the API implementing component.

An API allows a developer of an API calling component (that could be a third party developer) to utilize specified features provided by an API implementing component. There may be one API calling component or there may be more than one such component. An API can be a source code interface that a computing system or program library provides to support requests for services from an application. An operating system (OS) can have multiple APIs to allow applications running on the OS to call one or more of those APIs, and a service (such as a program library) can have multiple APIs to allow an application that uses the service to call one or more of those APIs. An API can be specified in terms of a programming language that can be interpreted or compiled when an application is built.

In some configurations the API implementing component may provide more than one API, each providing a different view of or with different aspects that access different aspects of the functionality implemented by the API implementing component. For example, one API of an API implementing component can provide a first set of functions and can be exposed to third party developers, and another API of the API implementing component can be hidden (not exposed) and provide a subset of the first set of functions and also provide another set of functions, such as testing or debugging functions which are not in the first set of functions. In other configurations the API implementing component may itself call one or more other components via an underlying API and thus be both an API calling component and an API implementing component.

An API defines the language and parameters that API calling components use when accessing and using specified features of the API implementing component. For example, an API calling component accesses the specified features of the API implementing component through one or more API calls or invocations (embodied for example by function or method calls) exposed by the API and passes data and control information using parameters via the API calls or invocations. The API implementing component may return a value through the API in response to an API call from an API calling component. While the API defines the syntax and result of an API call (e.g., how to invoke the API call and what the API call does), the API may not reveal how the API call accomplishes the function specified by the API call. Various API calls are transferred via the one or more application programming interfaces between the calling (API calling component) and an API implementing component. Transferring the API calls may include issuing, initiating, invoking, calling, receiving, returning, or responding to the function calls or messages. In other words, transferring can describe actions by either of the API calling component or the API implementing component. The function calls or other invocations of the API may send or receive one or more parameters through a parameter list or other structure. A parameter can be a constant, key, data structure, object, object class, variable, data type, pointer, array, list or a pointer to a function or method or another way to reference a data or other item to be passed via the API.

Furthermore, data types or classes may be provided by the API and implemented by the API implementing component. The API calling component therefore can declare variables, use pointers to, use or instantiate constant values of such types or classes by using definitions provided in the API.

Generally, an API can be used to access a service or data provided by the API implementing component or to initiate performance of an operation or computation provided by the API implementing component. By way of example, the API implementing component and the API calling component may each be any one of an operating system, a library, a device driver, an API, an application program, or other module (it should be understood that the API implementing component and the API calling component may be the same or different type of module from each other). API implementing components may in some cases be embodied at least in part in firmware, microcode, or other hardware logic. In some configurations, an API may allow a client program to use the services provided by a Software Development Kit (SDK) library. In other configurations an application or other client program may use an API provided by an Application Framework. In these configurations the application or client program may incorporate calls to functions or methods provided by the SDK and provided by the API or use data types or objects defined in the SDK and provided by the API. An Application Framework may in these configurations provide a main event loop for a program that responds to various events defined by the Framework. The API allows the application to specify the events and the responses to the events using the Application Framework. In some implementations, an API call can report to an application the capabilities or state of a hardware device, including those related to aspects such as input capabilities and state, output capabilities and state, processing capability, power state, storage capacity and state, communications capability, etc., and the API may be implemented in part by firmware, microcode, or other low level logic that executes in part on the hardware component.

The API calling component may be a local component (i.e., on the same data processing system as the API implementing component) or a remote component (i.e., on a different data processing system from the API-implementing component) that communicates with the API-implementing component through the API over a network. It should be understood that an API implementing component may also act as an API calling component (i.e., it may make API calls to an API exposed by a different API implementing component) and an API calling component may also act as an API implementing component by implementing an API that is exposed to a different API calling component.

The API can allow multiple API calling components written in different programming languages to communicate with the API implementing component (thus the API may include features for translating calls and returns between the API implementing component and the API calling component). The API however can be implemented in terms of a specific programming language. An API calling component can, in one configuration, call APIs from different providers such as a set of APIs from an OS provider and another set of APIs from a plug-in provider and another set of APIs from another provider (e.g. the provider of a software library) or creator of the another set of APIs.

The following description describes an example API architecture in which some configurations of the subject technology can be implemented.

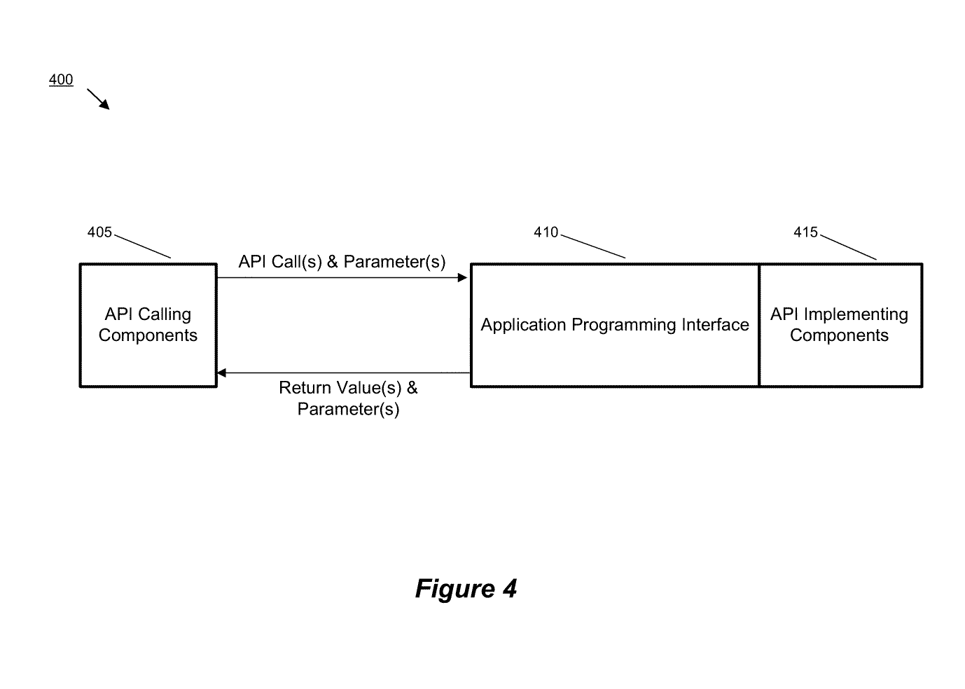

FIG. 4 is a block diagram illustrating an example API architecture, which can be used in some configurations of the subject technology. As shown in FIG. 4, the API architecture 400 includes the API implementing component 415 (e.g., an operating system, a library, a device driver, an API, an application program, software or other module) that implements the API 410. The API 410 specifies one or more functions, methods, classes, objects, protocols, data structures, formats and/or other features of the API-implementing component that can be used by the API-calling component 405. The API 410 can specify at least one calling convention that specifies how a function in the API implementing component receives parameters from the API calling component and how the function returns a result to the API calling component. The API calling component 405 (e.g., an operating system, a library, a device driver, an API, an application program, software or other module), makes API calls through the API 410 to access and use the features of the API implementing component 415 that are specified by the API 410. The API implementing component 415 can return a value through the API 410 to the API calling component 405 in response to an API call.

It will be appreciated that the API implementing component 415 can include additional functions, methods, classes, data structures, and/or other features that are not specified through the API 410 and are not available to the API calling component 405. It should be understood that the API calling component 405 can be on the same system as the API implementing component 415 or can be located remotely and accesses the API implementing component 415 using the API 410 over a network. While FIG. 4 illustrates a single API calling component 405 interacting with the API 410, it should be understood that other API calling components, which can be written in different languages (or the same language) than the API calling component 405, can use the API 410.

The API implementing component 415, the API 410, and the API calling component 405 can be stored in a machine-readable medium, which includes any mechanism for storing information in a form readable by a machine (e.g., a computer or other data processing system). For example, a machine-readable medium includes magnetic disks, optical disks, random access memory, read only memory, flash memory devices, etc.

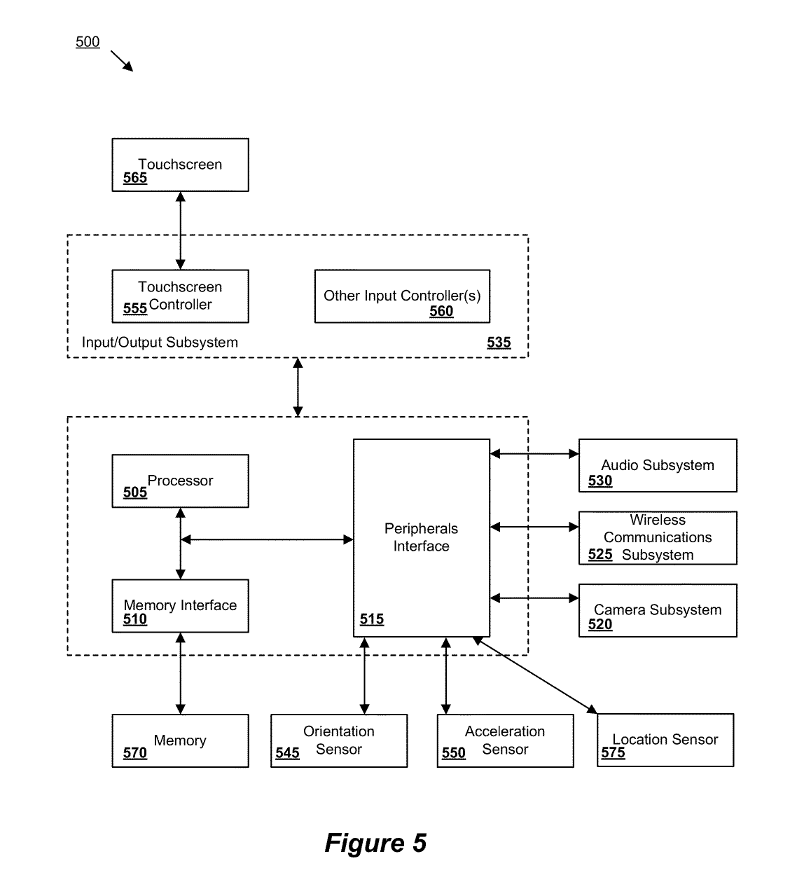

FIG. 5 is an example of a mobile device architecture 500. The implementation of a mobile device can include one or more processing units 505, memory interface 510 and a peripherals interface 515. Each of these components that make up the computing device architecture can be separate components or integrated in one or more integrated circuits. These various components can also be coupled together by one or more communication buses or signal lines.

The peripherals interface 515 can be coupled to various sensors and subsystems, including a camera subsystem 520, a wireless communication subsystem(s) 525, audio subsystem 530 and Input/Output subsystem 535. The peripherals interface 515 enables communication between processors and peripherals. The peripherals provide different functionality for the mobile device. Peripherals such as an orientation sensor 545 or an acceleration sensor 550 can be coupled to the peripherals interface 515 to facilitate the orientation and acceleration functions. Additionally, the mobile device can include a location sensor 575 to provide different location data. In particular, the location sensor can utilize a Global Positioning System (GPS) to provide different location data such as longitude, latitude and altitude.

The camera subsystem 520 can be coupled to one or more optical sensors such as a charged coupled device (CCD) optical sensor or a complementary metal-oxide-semiconductor (CMOS) optical sensor. The camera subsystem 520 coupled with the sensors can facilitate camera functions, such as image and/or video data capturing. Wireless communication subsystems 525 can serve to facilitate communication functions. Wireless communication subsystems 525 can include radio frequency receivers and transmitters, and optical receivers and transmitters. The aforementioned receivers and transmitters can be implemented to operate over one or more communication networks such as a Long Term Evolution (LTE), Global System for Mobile Communications (GSM) network, a Wi-Fi network, Bluetooth network, etc. The audio subsystem 530 is coupled to a speaker and a microphone to facilitate voice-enabled functions, such as voice recognition, digital recording, etc.

I/O subsystem 535 involves the transfer between input/output peripheral devices, such as a display, a touchscreen, etc., and the data bus of the processor 505 through the Peripherals Interface. I/O subsystem 535 can include a touchscreen controller 555 and other input controllers 560 to facilitate these functions. Touchscreen controller 555 can be coupled to the touchscreen 565 and detect contact and movement on the screen using any of multiple touch sensitivity technologies. Other input controllers 560 can be coupled to other input/control devices, such as one or more buttons.

Memory interface 510 can be coupled to memory 570, which can include high-speed random access memory and/or non-volatile memory such as flash memory. Memory 570 can store an operating system (OS). The OS can include instructions for handling basic system services and for performing hardware dependent tasks.

By way of example, memory can also include communication instructions to facilitate communicating with one or more additional devices, graphical user interface instructions to facilitate graphic user interface processing, image/video processing instructions to facilitate image/video-related processing and functions, phone instructions to facilitate phone-related processes and functions, media exchange and processing instructions to facilitate media communication and processing-related processes and functions, camera instructions to facilitate camera-related processes and functions, and video conferencing instructions to facilitate video conferencing processes and functions. The above identified instructions need not be implemented as separate software programs or modules. Various functions of mobile device can be implemented in hardware and/or in software, including in one or more signal processing and/or application specific integrated circuits.

The following description describes an example system in which aspects of the subject technology can be implemented.

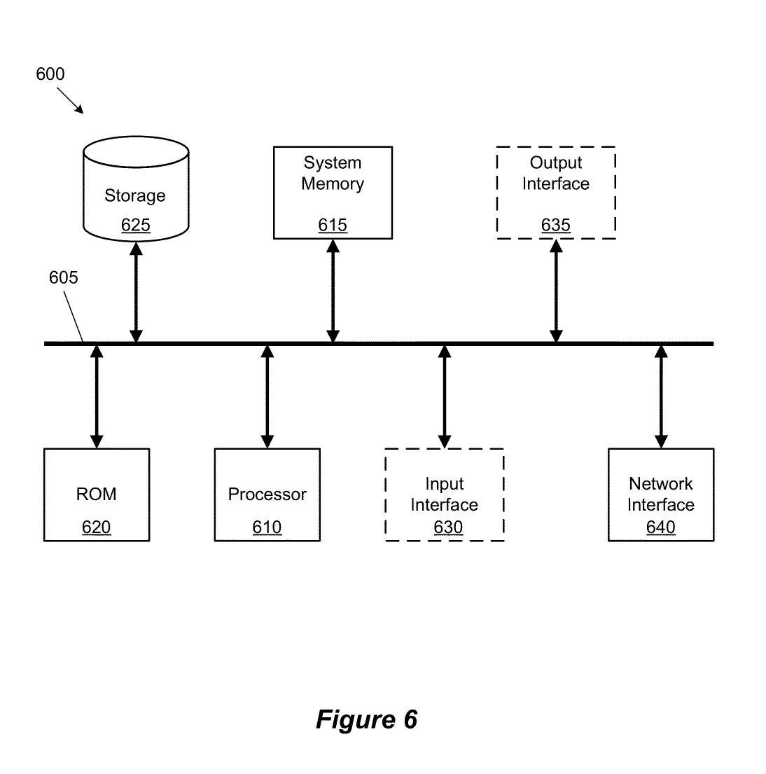

FIG. 6 conceptually illustrates a system 600 with which some implementations of the subject technology can be implemented. The system 600 can be a computer, phone, PDA, or any other sort of electronic device. In some configurations, the system 600 includes a television with one or more processors embedded therein. Such a system includes various types of computer readable media and interfaces for various other types of computer readable media. The system 600 includes a bus 605, processing unit(s) 610, a system memory 615, a read-only memory 620, a storage device 625, an optional input interface 630, an optional output interface 635, and a network interface 640.

The bus 605 collectively represents all system, peripheral, and chipset buses that communicatively connect the numerous internal devices of the system 600. For instance, the bus 605 communicatively connects the processing unit(s) 610 with the read-only memory 620, the system memory 615, and the storage device 625.

From these various memory units, the processing unit(s) 610 retrieves instructions to execute and data to process in order to execute the processes of the subject technology. The processing unit(s) can be a single processor or a multi-core processor in different implementations.

The read-only-memory (ROM) 620 stores static data and instructions that are needed by the processing unit(s) 610 and other modules of the system 600. The storage device 625, on the other hand, is a read-and-write memory device. This device is a non-volatile memory unit that stores instructions and data even when the system 600 is off. Some implementations of the subject technology use a mass-storage device (such as a magnetic or optical disk and its corresponding disk drive) as the storage device 625.

Other implementations use a removable storage device (such as a flash drive, a floppy disk, and its corresponding disk drive) as the storage device 625. Like the storage device 625, the system memory 615 is a read-and-write memory device. However, unlike storage device 625, the system memory 615 is a volatile read-and-write memory, such a random access memory. The system memory 615 stores some of the instructions and data that the processor needs at runtime. In some implementations, the subject technology's processes are stored in the system memory 615, the storage device 625, and/or the read-only memory 620. For example, the various memory units include instructions for processing multimedia items in accordance with some implementations. From these various memory units, the processing unit(s) 610 retrieves instructions to execute and data to process in order to execute the processes of some implementations.

The bus 605 also connects to the optional input and output interfaces 630 and 635. The optional input interface 630 enables the user to communicate information and select commands to the system. The optional input interface 630 can interface with alphanumeric keyboards and pointing devices (also called “cursor control devices”). The optional output interface 635 can provide display images generated by the system 600. The optional output interface 635 can interface with printers and display devices, such as cathode ray tubes (CRT) or liquid crystal displays (LCD). Some implementations can interface with devices such as a touchscreen that functions as both input and output devices.

Finally, as shown in FIG. 6, bus 605 also couples system 600 to a network interface 640 through a network adapter (not shown). In this manner, the computer can be a part of a network of computers (such as a local area network (“LAN”), a wide area network (“WAN”), or an Intranet, or an interconnected network of networks, such as the Internet. Any or all components of system 600 can be used in conjunction with the subject technology.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Configurations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some configurations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes can be rearranged, or that all illustrated steps be performed. Some of the steps can be performed simultaneously. For example, in certain circumstances, multitasking and parallel processing can be advantageous. Moreover, the separation of various system components in the configurations described above should not be understood as requiring such separation in all configurations, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein can be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase such as an “aspect” does not imply that such aspect is essential to the subject technology or that such aspect applies to all configurations of the subject technology. A disclosure relating to an aspect can apply to all configurations, or one or more configurations. A phrase such as an aspect can refer to one or more aspects and vice versa. A phrase such as a “configuration” does not imply that such configuration is essential to the subject technology or that such configuration applies to all configurations of the subject technology. A disclosure relating to a configuration can apply to all configurations, or one or more configurations. A phrase such as a configuration can refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

1. A machine-implemented method for providing a custom overlay for a dialog box in an application, the method comprising:
detecting a click event in content displayed in the application for activating a dialog box, wherein the content is provided by a different source than the application;
providing, in response to the detected click event, an overlay in the application before the dialog box is rendered by the application, the overlay including instructions for a user to interact with the dialog box; and
providing for display the overlay and the dialog box rendered by the application.

2. The method of claim 1, wherein the application is a web browser.

3. The method of claim 2, wherein the click event occurs in a web page displayed by the web browser.

4. The method of claim 3, wherein the overlay is provided for display in the web page.

5. The method of claim 3, wherein the web page is provided by a web site.

6. The method of claim 1, further comprising:
receiving user input for interacting with the dialog box; and
providing for display a second content responsive to the received user input.

7. The method of claim 6, wherein the second content comprises a second web page.

8. The method of claim 7, wherein the received user input comprises one or more types of input.

9. The method of claim 8, wherein the one or more types of input include mouse input, keyboard input, touch input, or voice input.

10. The method of claim 1, wherein the click event corresponds with a button selection in the content.

11. The method of claim 1, wherein the overlay comprises one or more different HTML elements that wrap around the dialog box.

12. The method of claim 11, wherein at least one of the different HTML elements is pre-cached by the web browser.

13. The method of claim 1, wherein the overlay is dynamically generated.

14. The method of claim 1, wherein the overlay is rendered according to an opacity setting to provide a transparency effect over the content.

15. The method of claim 1, wherein the dialog box comprises a modal dialog box.

16. A system for providing a custom overlay for a dialog box in an application, the system comprising:
a memory;
one or more processors;
one or more modules stored in the memory and configured for execution by the one or more processors, the modules comprising:
an event detection module configured to detect a click event in content displayed in the application for activating a dialog box, wherein the content is provided by a different source than the application and the different source comprises a web site located over a network;
an overlay module configured to provide, in response to the detected click event, an overlay in the application before the dialog box is rendered by the application, the overlay including instructions for a user to interact with the dialog box; and
a graphical user interface (GUI) module configured to provide for display the overlay and the dialog box rendered by the application.

17. The system of claim 16, further comprising:
a dialog interaction module configured to receive user input for interacting with the dialog box.

18. The system of claim 17, wherein the GUI module is further configured to provide for display a second content responsive to the received user input.

19. The system of claim 16, wherein the click event corresponds with a button selection in the content.

20. The system of claim 16, wherein the overlay comprises one or more different HTML elements that wrap around the dialog box.

21. The system of claim 20, wherein at least one of the different HTML elements is pre-cached by the web browser.

22. The system of claim 16, wherein the overlay is dynamically generated.

23. The system of claim 16, wherein the overlay is rendered according to an opacity setting to provide a transparency effect over the content.

24. The system of claim 16, wherein the dialog box comprises a modal dialog box.

25. A machine-readable medium comprising instructions stored therein, which when executed by a machine, cause the machine to perform operations comprising:
detecting a click event in content displayed in an application for activating a dialog box, wherein the content is provided by a different source than the application, and the application is a web browser;
providing, in response to the detected click event, an overlay in the application before the dialog box is rendered by the application, the overlay including instructions for a user to interact with the dialog box and one or more HTML elements that are pre-cached; and
providing for display the overlay and the dialog box rendered by the application, wherein the overlay is displayed before the dialog box is rendered by the application.

26. The method of claim 1, wherein the instructions comprise textual instructions.
